(19) United States
(12) Patent Application Publication
(10) Pub. No.: US 2025/0357695 A1
(43) Pub. Date: Nov. 20, 2025

(54) CONDUCTIVE MODULE

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP)

(21) Appl. No.: 19/204,449

(22) Filed: May 9, 2025

(30) Foreign Application Priority Data
May 15, 2024 (JP) 2024-079298

(51) Int. Cl. H01R 13/405; H01M 50/507; H01R 4/02; H01R 11/11; H01R 101/00

(52) U.S. Cl. CPC H01R 13/405; H01M 50/507; H01R 4/02; H01R 11/11; H01R 2101/00

(57) ABSTRACT

A conductive module includes that a bus bar; a wiring component that electrically connects the bus bar to a battery monitoring unit; an electrical connection component that solders a first electrode to a first electrical connection portion on a bus bar side and solders a second electrode to a second electrical connection portion of a wiring terminal of the wiring component; and an insulating member that encloses the electrical connection component, the first electrical connection portion, and the second electrical connection portion are included.

### CROSS-REFERENCE TO RELATED APPLICATION(S)

The present application claims priority to and incorporates by reference the entire contents of Japanese Patent Application No. 2024-079298 filed in Japan on May 15, 2024.

### BACKGROUND OF THE INVENTION

### 1. Field of the Invention

The present invention relates to a conductive module.

### 2. Description of the Related Art

The conductive module electrically connects a plurality of battery cells using a plurality of bus bars in a battery module in which the plurality of battery cells is arranged. Then, in the conductive module, each bus bar is electrically connected to a battery monitoring unit that monitors the battery state of the battery cell using a wiring component such as an electric wire. This type of conductive module is disclosed in, for example, Japanese Patent Application Laid-open No. 2020-119651.

Meanwhile, in the conductive module, there is a case where electrical connection components are provided that are soldered to the bus bar side and the wiring component side and are physically and electrically connected to the bus bar side and the wiring component side. For example, as the electrical connection component, a chip component such as a chip fuse having a fusible portion which is fused when an overcurrent flows, a circuit component such as a pattern fuse in which a wiring pattern having a fusible portion is provided on a printed circuit board, and the like can be considered. In this conductive module, when forces in different directions are generated between the bus bar side and the wiring component side and the loads act on the solder connection portion of the electrical connection component, there is a possibility that the conduction performance in the solder connection portion is deteriorated.

### SUMMARY OF THE INVENTION

Therefore, an object of the present invention is to provide a conductive module capable of protecting a solder connection portion of an electrical connection component.

A conductive module according to one aspect of the invention includes a bus bar that is physically and electrically connected to an electrode terminal of a battery cell constituting a battery module; a wiring component that includes a wiring terminal and electrically connects the bus bar to a battery monitoring unit monitoring a battery state of the battery cell; an electrical connection component that solders a first electrode to a first electrical connection portion on a bus bar side and solders a second electrode to a second electrical connection portion of the wiring terminal; and an insulating member that encloses the electrical connection component, the first electrical connection portion, and the second electrical connection portion, wherein the electrical connection component is a chip component including the first electrode and the second electrode or a circuit component provided with a wiring pattern including the first electrode and the second electrode, and is installed across the first electrical connection portion and the second electrical connection portion disposed to face each other with a gap therebetween, the insulating member is a molded body insert-molded while enclosing the electrical connection component, the first electrical connection portion, and the second electrical connection portion, or a cured body obtained by curing a potting liquid enclosing the electrical connection component, the first electrical connection portion, and the second electrical connection portion, and the first electrical connection portion and the second electrical connection portion each have a locked portion that is in close contact with the insulating member inside and is locked to the insulating member in a facing disposition direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is an exploded perspective view illustrating the conductive module according to the embodiment;

FIG. 3 is a schematic view illustrating a battery module together with bus bars;

FIG. 4 is a perspective view of the conductive module describing a modification aspect of an electrical connection component;

FIG. 5 is an exploded perspective view of the conductive module describing a modification aspect of the electrical connection component;

FIG. 6 is a perspective view illustrating a conductive module according to a first modification;

FIG. 7 is an exploded perspective view illustrating the conductive module according to the first modification;

FIG. 8 is a perspective view illustrating a conductive module according to a second modification;

FIG. 9 is an exploded perspective view illustrating the conductive module according to the second modification;

FIG. 10 is a perspective view describing notches;

FIG. 11 is a perspective view illustrating a conductive module according to a third modification; and

FIG. 12 is an exploded perspective view illustrating the conductive module according to the third modification.

### DETAILED DESCRIPTION OF THE PREFERRED EMBODIMENTS

Hereinafter, an embodiment of the conductive module according to the present invention will be described in detail with reference to the drawings. Note that this invention is not limited by this embodiment.

### Embodiment

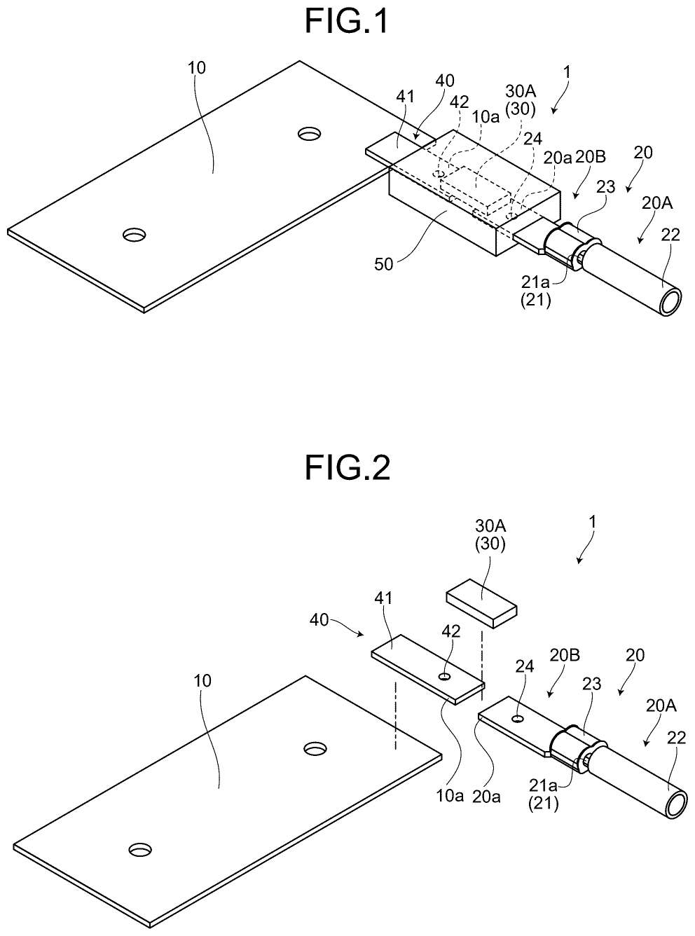

One embodiment of the conductive module according to the present invention will be described with reference to FIGS. 1 to 5.

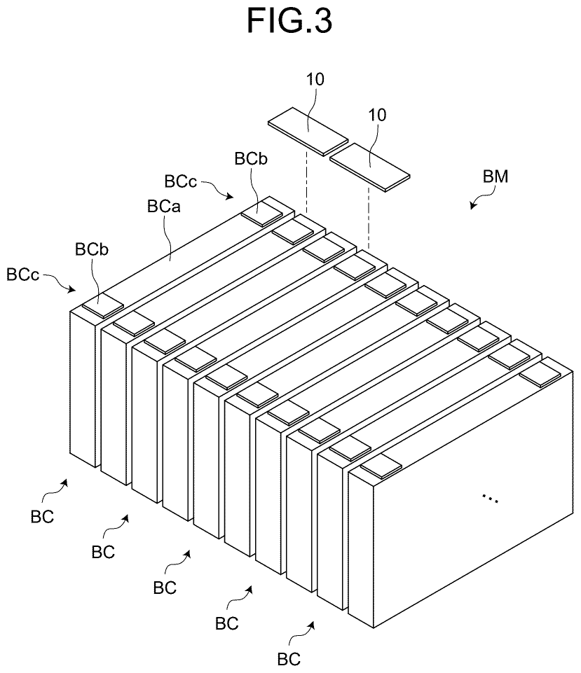

Reference numeral 1 in FIGS. 1 and 2 denotes a conductive module of the present embodiment. The conductive module 1 is assembled to a battery module BM (FIG. 3) in which a plurality of battery cells BC is arranged (e.g., arranged in a row), and electrically connects the plurality of battery cells BC in the battery module BM. In addition, the conductive module 1 electrically connects the battery module BM to a battery monitoring unit (illustration omitted) to cause the battery monitoring unit to monitor the battery state of the battery cells BC. The conductive module 1 constitutes a battery pack together with the battery module BM. The battery pack is mounted on, for example, a vehicle (battery electric vehicle (BEV), hybrid electric vehicle (HEV), or the like) including a rotary machine as a drive source, and is used for power supply to the rotary machine.

The battery cell BC includes a cell body BCa and positive and negative electrode terminals BCb (FIG. 3). In the battery cell BC illustrated here, the cell body BCa is formed in a rectangular parallelepiped shape having six outer wall surfaces. Then, in the plurality of battery cells BC constituting the battery module BM, the cell bodies BCa adjacent to each other in the arrangement direction are disposed with one outer wall surface facing each other. The battery module BM includes one electrode terminal group BCc in which electrode terminals BCb of the battery cells BC on one side are arranged along the arrangement direction, and the other electrode terminal group BCc in which electrode terminals BCb of the battery cells BC on the other side are arranged along the arrangement direction (FIG. 3).

In this example, each battery cell BC includes positive and negative electrode terminals BCb on one of the six outer wall surfaces of the cell body BCa (FIG. 3). Therefore, in the battery module BM, two electrode terminal groups BCc are provided on one plane (FIG. 3).

In addition, the electrode terminals BCb illustrated here are formed in a flat plate shape, and physically and electrically connect bus bars 10 to be described below by welding or the like (FIG. 3). However, the electrode terminals BCb may be formed in a pole shape having a male screw portion. In this case, the bus bar 10 is fixedly screwed to the electrode terminal BCb by screwing a female screw member to the male screw portion of the electrode terminal BCb.

The conductive module 1 includes bus bars 10 that are physically and electrically connected to the electrode terminals BCb of the battery cells BC constituting the battery module BM (FIGS. 1 to 3).

The bus bars 10 are molded of a conductive material such as metal. The bus bars 10 are plate-shaped conductive components made of metal, and are press-molded using, for example, a metal plate as a base material. The bus bars 10 illustrated here are molded in a rectangular flat plate shape.

The conductive module 1 includes, as the bus bars 10, for example, one that is physically and electrically connected to the adjacent electrode terminals BCb of a pair of battery cells BC of the battery module BM, one that is physically and electrically connected to the electrode terminal BCb serving as the total negative electrode of the battery module BM, and one that is physically and electrically connected to the electrode terminal BCb serving as the total positive electrode of the battery module BM.

The conductive module 1 includes a wiring component 20 that electrically connects the bus bar 10 to the battery monitoring unit (FIGS. 1 and 2). Then, the conductive module 1 includes an electrical connection component 30 interposed between the bus bar 10 and the wiring component 20 (FIGS. 1 and 2). In the conductive module 1, the electrical connection component 30 is physically and electrically connected to an electrical connection portion (hereinafter, referred to as a “first electrical connection portion”) 10a on the bus bar 10 side and an electrical connection portion (hereinafter, referred to as a “second electrical connection portion”) 20a on the wiring component 20 side, and the bus bar 10 and the battery monitoring unit are electrically connected via the electrical connection component 30. In the conductive module 1, the wiring component 20 and the electrical connection component 30 are provided for each bus bar 10.

The wiring component 20 includes an electric wire (hereinafter, referred to as a “wiring electric wire”) 20A in which a core wire 21 is covered with an insulating sheath 22 (FIGS. 1 and 2). In the wiring electric wire 20A, the core wire 21 is exposed in a state of protruding from the insulating sheath 22 at the terminal thereof. Hereinafter, the exposed portion of the core wire 21 is referred to as a core wire exposed portion 21a.

The wiring component 20 includes a terminal fitting (hereinafter, referred to as a “wiring terminal”) 20B physically and electrically connected to the core wire exposed portion 21a (FIGS. 1 and 2). In the wiring component 20, the wiring terminal 20B is provided with the second electrical connection portion 20a.

The wiring terminal 20B is molded of a conductive material such as metal. The wiring terminal 20B includes an electric wire connection portion 23 that is physically and electrically connected to the core wire exposed portion 21a of the wiring electric wire 20A (FIGS. 1 and 2). The wiring terminal 20B illustrated here is molded as a terminal fitting extending in one direction, and one end thereof in the longitudinal direction is defined as the second electrical connection portion 20a, and the other end thereof in the longitudinal direction is defined as the electric wire connection portion 23. One end side of the wiring terminal 20B in the longitudinal direction is formed in a rectangular flat plate shape. Then, the electric wire connection portion 23 illustrated here is formed as a crimp terminal portion to be swaged and crimped to the core wire exposed portion 21a.

The electrical connection component 30 includes a first electrode and a second electrode. In the electrical connection component 30, the first electrode is soldered to the first electrical connection portion 10a on the bus bar 10 side, and the second electrode is soldered to the second electrical connection portion 20a of the wiring terminal 20B.

The electrical connection component 30 of the present embodiment is a chip component 30A including the first electrode and the second electrode. For example, the chip component 30A is a chip fuse including a fusible portion that is fused when an overcurrent flows, the first electrode provided on one end side as viewed from the fusible portion, and the second electrode provided on the other end side as viewed from the fusible portion.

The conductive module 1 of the present embodiment includes a conductive member (hereinafter, referred to as a “bus bar-side conductive member”) 40 interposed between the bus bar 10 and the electrical connection component 30 and physically and electrically connected to the bus bar 10 and the first electrode of the electrical connection component 30 (FIGS. 1 and 2). The first electrical connection portion 10a on the bus bar 10 side is provided in the bus bar-side conductive member 40. In the conductive module 1, the bus bar-side conductive member 40 is provided for each bus bar 10.

The bus bar-side conductive member 40 is molded of a conductive material such as metal. For example, the bus bar-side conductive member 40 is molded as a terminal fitting. The bus bar-side conductive member 40 illustrated here is molded as a flat plate-shaped terminal fitting extending in one direction, and has one end in the longitudinal direction as the first electrical connection portion 10a and the other end in the longitudinal direction as a bus bar connection portion 41 that is physically and electrically connected to the bus bar 10 (FIGS. 1 and 2). Here, the bus bar-side conductive member 40 is molded in a rectangular flat plate shape.

The bus bar-side conductive member 40 physically and electrically connects the bus bar connection portion 41 to the bus bar 10 in a state where the first electrical connection portion 10a protrudes from the bus bar 10 in a direction orthogonal to the arrangement direction of the plurality of battery cells BC. In the conductive module 1, the bus bar connection portion 41 and the bus bar 10 are physically and electrically connected by welding or the like. Note that the bus bar-side conductive member 40 may physically and electrically connect the bus bar connection portion 41 and the bus bar 10 by screwing fixedly. In addition, in the bus bar-side conductive member 40, the bus bar connection portion 41 may be formed as a female terminal portion or a male terminal portion, and the bus bar connection portion 41 may be male-female fit connected to a male terminal portion or a female terminal portion of the bus bar 10.

The first electrical connection portion 10a on the bus bar 10 side and the second electrical connection portion 20a of the wiring terminal 20B are disposed to face each other with a gap therebetween. The electrical connection component 30 is installed across the first electrical connection portion 10a and the second electrical connection portion 20a. Here, with respect to the first electrical connection portion 10a of the bus bar-side conductive member 40, the second electrical connection portion 20a of the wiring terminal 20B is disposed with a gap in the direction orthogonal to the arrangement direction of the plurality of battery cells BC. Then, in this case, the electrical connection component 30 extends between the first electrical connection portion 10a and the second electrical connection portion 20a over the gap. In the electrical connection component 30, the first electrode is soldered to the first electrical connection portion 10a, and the second electrode is soldered to the second electrical connection portion 20a.

The conductive module 1 includes an insulating member 50 enclosing the electrical connection component 30, the first electrical connection portion 10a, and the second electrical connection portion 20a in order to maintain the connection state (FIG. 1). The insulating member 50 is molded of an insulating material such as synthetic resin. For example, the insulating member 50 is a molded body insert-molded by enclosing the electrical connection component 30, the first electrical connection portion 10a, and the second electrical connection portion 20a, or a cured body obtained by curing a potting liquid enclosing the electrical connection component 30, the first electrical connection portion 10a, and the second electrical connection portion 20a.

The first electrical connection portion 10a and the second electrical connection portion 20a are in close contact with the insulating member 50 inside, and respectively have locked portions 42 and 24 to be locked to the insulating member 50 in the facing disposition direction (FIGS. 1 and 2). The locked portions 42 and 24 are through-holes provided in the first electrical connection portion 10a and the second electrical connection portion 20a, respectively. In the locked portions 42 and 24, the through-holes are filled with a part of the insulating member 50.

The locked portions 42 and 24 illustrated here are arranged in the facing disposition direction of the first electrical connection portion 10a and the second electrical connection portion 20a with the electrical connection component 30 placed therebetween. In addition, the locked portions 42 and 24 illustrated here are each formed as a circular through-hole.

In the conductive module 1, the locked portions 42 and 24 are filled with a part of the insulating member 50 in a solidified state, and the locked portions 42 and 24 can be locked by the insulating member 50 in the locked portions 42 and 24. Therefore, in this conductive module 1, when a load causing approaching or separating from each other is applied to the bus bar-side conductive member 40 or the wiring terminal 20B, the force is transmitted from the locked portions 42 and 24 to the insulating member 50 within the locked portions 42 and 24, and the insulating member 50 in the locked portions 42 and 24 receives the force, so that the transmission of the force to the electrical connection component 30 can be suppressed as compared with the case where the locked portions 42 and 24 are not provided. Accordingly, in the conductive module 1 according to the present embodiment, the load applied to the solder connection portion between the first electrode of the electrical connection component 30 and the first electrical connection portion 10a of the bus bar-side conductive member 40 and the solder connection portion between the second electrode of the electrical connection component 30 and the second electrical connection portion 20a of the wiring terminal 20B can be suppressed low, and each solder connection portion can be protected. Therefore, the conductive module 1 can maintain conduction performance between the first electrode and the first electrical connection portion 10a and between the second electrode and the second electrical connection portion 20a.

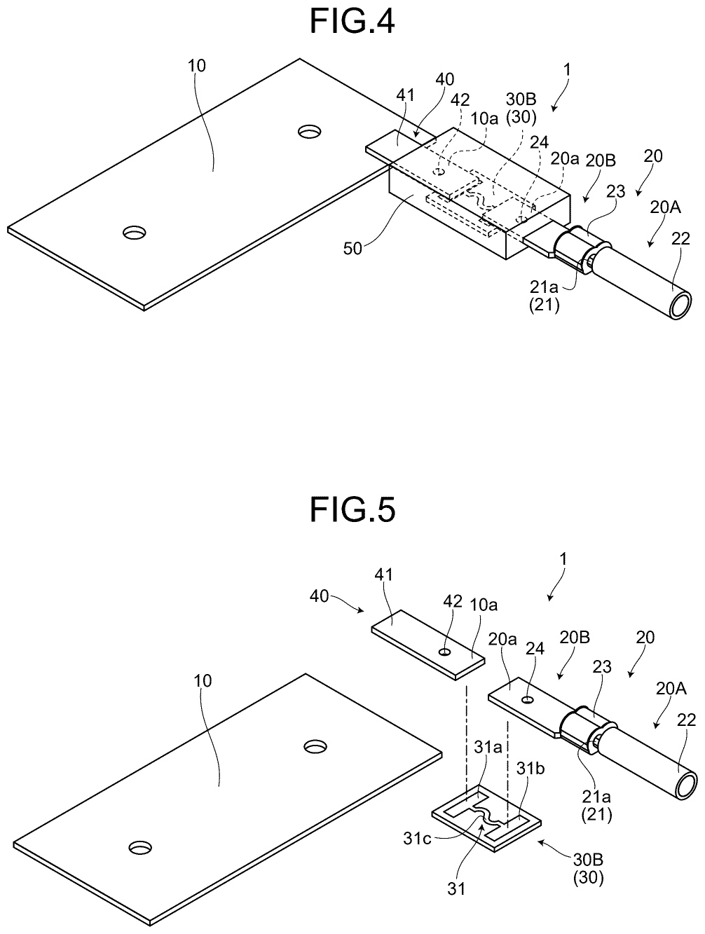

Here, the electrical connection component 30 may be a circuit component 30B provided with a wiring pattern having a first electrode and a second electrode. For example, the circuit component 30B is a pattern fuse in which a wiring pattern 31 is provided on a printed circuit board (flexible printed circuit board or rigid board). The wiring pattern 31 is provided with a first electrode 31a physically and electrically connected to the first electrical connection portion 10a of the bus bar-side conductive member 40, and a second electrode 31b physically and electrically connected to the second electrical connection portion 20a of the wiring terminal 20B (FIGS. 4 and 5). Then, in the wiring pattern 31, a fusible portion 31c is provided between the first electrode 31a and the second electrode 31b (FIGS. 4 and 5).

In the conductive module 1, for example, the first electrical connection portion 10a of the bus bar-side conductive member 40 and the second electrical connection portion 20a of the wiring terminal 20B are placed on the first electrode 31a and the second electrode 31b of the circuit component 30B, respectively, and the circuit component 30B is soldered to be physically and electrically connected to the first electrical connection portion 10a and the second electrical connection portion 20a.

### First Modification

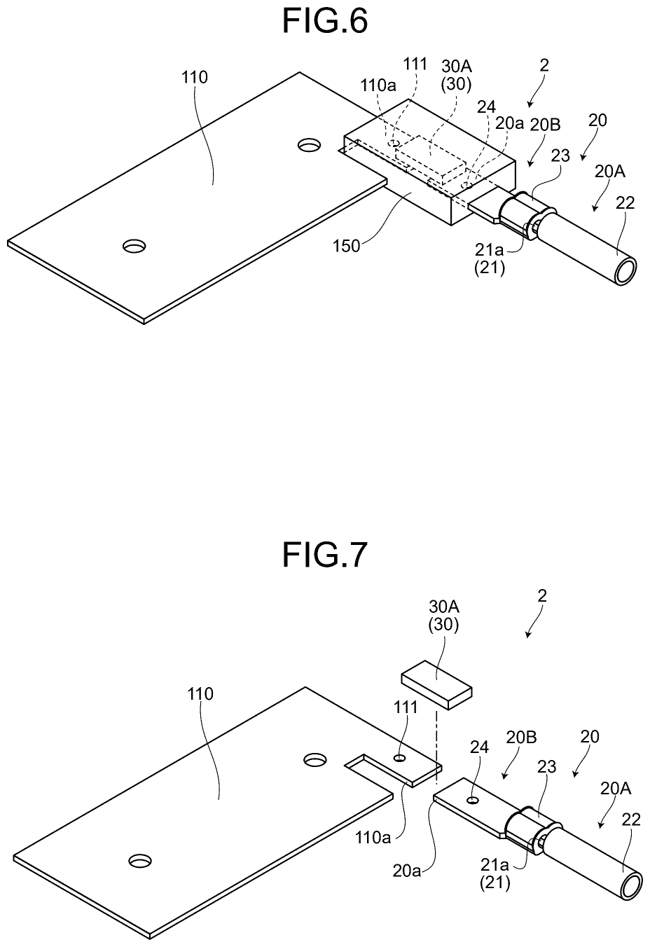

A conductive module 2 of the present modification is obtained by removing the bus bar-side conductive member 40 and replacing the bus bar 10 with a bus bar 110 described below in the conductive module 1 of the above-described embodiment (FIGS. 6 and 7). Therefore, in the present modification, the same members, portions, and the like as those of the conductive module 1 of the embodiment are denoted by the same reference numerals as those of the embodiment, and the description thereof will be omitted. In addition, the electrical connection component 30 of the present modification may be the chip component 30A or the circuit component 30B as in the embodiment. Here, the electrical connection component 30 configured as the chip component 30A is illustrated.

In the conductive module 2 of the present modification, a first electrical connection portion 110a is provided in the bus bar 110, and the first electrical connection portion 110a and the first electrode of the electrical connection component 30 are physically and electrically connected by soldering (FIGS. 6 and 7). The bus bar 110 of the present modification is molded in a rectangular flat plate shape similarly to the bus bar 10 of the embodiment, but the first electrical connection portion 110a is provided by forming a notch in a part thereof. The first electrical connection portion 110a illustrated here is formed as a piece portion extending in a direction orthogonal to the arrangement direction of the plurality of battery cells BC at a corner portion of the bus bar 110.

The first electrical connection portion 110a of the bus bar 110 and the second electrical connection portion 20a of the wiring terminal 20B are disposed to face each other with a gap therebetween. The electrical connection component 30 is installed across the first electrical connection portion 110a and the second electrical connection portion 20a. Here, with respect to the first electrical connection portion 110a of the bus bar 110, the second electrical connection portion 20a of the wiring terminal 20B is disposed with a gap in the direction orthogonal to the arrangement direction of the plurality of battery cells BC. Then, in this case, the electrical connection component 30 extends between the first electrical connection portion 110a and the second electrical connection portion 20a over the gap. In the electrical connection component 30, the first electrode is soldered to the first electrical connection portion 110a, and the second electrode is soldered to the second electrical connection portion 20a.

Similarly to the conductive module 1 of the embodiment, the conductive module 2 includes an insulating member 150 enclosing the electrical connection component 30, the first electrical connection portion 110a, and the second electrical connection portion 20a in order to maintain the connection state (FIG. 6). The insulating member 150 is similar to the insulating member 50 of the embodiment. However, the insulating member 150 of the present modification is adapted to the shapes and disposition of the enclosed electrical connection component 30, first electrical connection portion 110a, and second electrical connection portion 20a.

Similarly to the first electrical connection portion 10a of the embodiment, the first electrical connection portion 110a has a locked portion 111 that is in close contact with the insulating member 150 inside and is locked to the insulating member 150 in the facing disposition direction with the second electrical connection portion 20a (FIGS. 6 and 7). The locked portion 111 is a circular through-hole similar to the locked portion 42 of the embodiment, and the through-hole is filled with a part of the insulating member 150.

Similarly to the conductive module 1 of the embodiment, the locked portions 111 and 24 illustrated here are arranged in the facing disposition direction of the first electrical connection portion 110a and the second electrical connection portion 20a with the electrical connection component 30 placed therebetween.

In the conductive module 2 of the present modification, the bus bar 10 is replaced with the bus bar 110 in the conductive module 1 of the embodiment, and the bus bar 110 has the function of the bus bar-side conductive member 40. Therefore, the conductive module 2 of the present modification can achieve the same effect as the conductive module 1 of the embodiment. Then, the conductive module 2 of the present modification corresponds to the conductive module 1 of the embodiment from which the bus bar-side conductive member 40 is removed, and can achieve size reduction and cost reduction as compared with the conductive module 1 of the embodiment.

### Second Modification

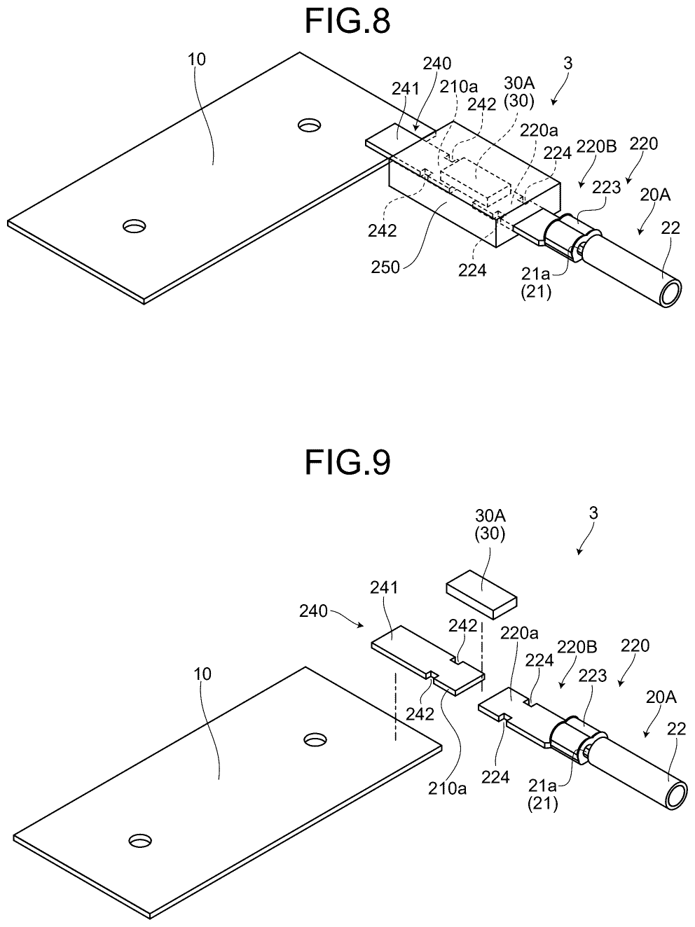

A conductive module 3 of the present modification is obtained by replacing the first electrical connection portion 10a and the second electrical connection portion 20a of the conductive module 1 of the above-described embodiment with first electrical connection portion 210a and second electrical connection portion 220a described below, or by replacing the first electrical connection portion 110a and the second electrical connection portion 20a of the conductive module 2 of the above-described first modification with the first electrical connection portion 210a and second electrical connection portion 220a described below (FIGS. 8 and 9). In addition, the electrical connection component 30 of the present modification may be the chip component 30A or the circuit component 30B as in the embodiment or the first modification.

Here, in the conductive module 1 of the embodiment, the wiring component 20 is replaced with a wiring component 220 described below, and the bus bar-side conductive member 40 is replaced with a bus bar-side conductive member 240 described below (FIGS. 8 and 9). Here, the electrical connection component 30 configured as the chip component 30A is illustrated.

The wiring component 220 of the present modification is obtained by replacing the wiring terminal 20B with a wiring terminal 220B in the wiring component 20 of the embodiment (FIGS. 8 and 9). Similarly to the wiring terminal 20B of the embodiment, the wiring terminal 220B of the present modification is molded as a terminal fitting extending in one direction, and one end thereof in the longitudinal direction is defined as the second electrical connection portion 220a, and the other end thereof in the longitudinal direction is defined as an electric wire connection portion 223. One end side of the wiring terminal 220B in the longitudinal direction is formed in a rectangular flat plate shape, and the second electrode of the electrical connection component 30 is physically and electrically connected to the second electrical connection portion 220a at one end thereof by soldering. Then, the electric wire connection portion 223 illustrated here is formed as a crimp terminal portion to be swaged and crimped to the core wire exposed portion 21a.

Similarly to the bus bar-side conductive member 40 of the embodiment, the bus bar-side conductive member 240 of the present modification is molded as a rectangular flat plate-shaped terminal fitting extending in one direction, and has one end in the longitudinal direction as the first electrical connection portion 210a and the other end in the longitudinal direction as a bus bar connection portion 241 that is physically and electrically connected to the bus bar 10 (FIGS. 8 and 9). The first electrode of the electrical connection component 30 is physically and electrically connected to the first electrical connection portion 210a by soldering. The bus bar-side conductive member 240 physically and electrically connects the bus bar connection portion 241 to the bus bar 10 by welding or the like in a state where the first electrical connection portion 210a protrudes from the bus bar 10 in a direction orthogonal to the arrangement direction of the plurality of battery cells BC.

Also in the present modification, the first electrical connection portion 210a on the bus bar 10 side and the second electrical connection portion 220a of the wiring terminal 220B are disposed to face each other with a gap therebetween in a direction orthogonal to the arrangement direction of the plurality of battery cells BC. Then, also in the present modification, the electrical connection component 30 is installed across the first electrical connection portion 210a and the second electrical connection portion 220a over the gap. In the electrical connection component 30, the first electrode is soldered to the first electrical connection portion 210a, and the second electrode is soldered to the second electrical connection portion 220a.

Similarly to the conductive module 1 of the embodiment, the conductive module 3 includes an insulating member 250 enclosing the electrical connection component 30, the first electrical connection portion 210a, and the second electrical connection portion 220a in order to maintain the connection state (FIG. 8). The insulating member 250 is similar to the insulating member 50 of the embodiment. However, the insulating member 250 of the present modification is adapted to the shapes and disposition of the enclosed electrical connection component 30, first electrical connection portion 210a, and second electrical connection portion 220a.

Similarly to the first electrical connection portion 10a and the second electrical connection portion 20a of the embodiment, the first electrical connection portion 210a and the second electrical connection portion 220a of the present modification have locked portions 242 and 224, respectively, that are in close contact with the insulating member 250 inside and are locked to the insulating member 250 in the facing disposition direction (FIGS. 8 and 9). However, the locked portions 242 and 224 of the present modification are notches provided in the first electrical connection portion 210a and the second electrical connection portion 220a, respectively. In the locked portions 242 and 224, the notches are filled with a part of the insulating member 250.

The locked portions 242 are provided on side portions of the first electrical connection portion 210a located in the direction orthogonal to the facing disposition direction with respect to the second electrical connection portion 220a. The locked portions 224 are provided on side portions of the second electrical connection portion 220a located in the direction orthogonal to the facing disposition direction with respect to the first electrical connection portion 210a. Here, one locked portion 242 or 224 is provided on each side portion of the first electrical connection portion 210a or the second electrical connection portion 220a.

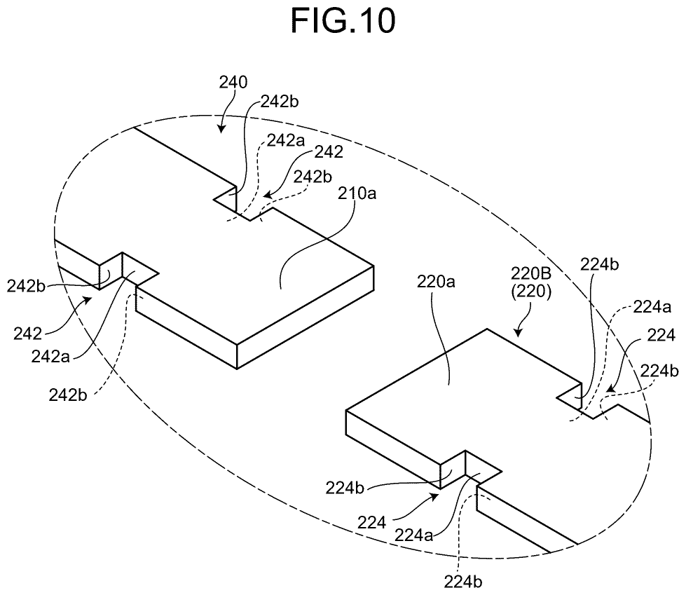

Here, the locked portions 242 and 224 (notches) have notch bottoms 242a and 224a located in the intersecting direction with respect to the facing disposition direction of the first electrical connection portion 210a and the second electrical connection portion 220a, and a pair of sidewalls 242b and 224b facing each other in the facing disposition direction (FIG. 10). The notches illustrated here are formed in a rectangular shape, and side portions located in a direction orthogonal to the facing disposition direction are defined as the notch bottoms 242a and 224a.

In the conductive module 3, the locked portions 242 and 224 are filled with a part of the insulating member 250 in a solidified state, and the locked portions 242 and 224 can be locked by the insulating member 250 in the locked portions 242 and 224. Therefore, in this conductive module 3, when a load causing approaching or separating from each other is applied to the bus bar-side conductive member 240 or the wiring terminal 220B, the force is transmitted from the locked portions 242 and 224 to the insulating member 250 within the locked portions 242 and 224, and the insulating member 250 in the locked portions 242 and 224 receives the force, so that the transmission of the force to the electrical connection component 30 can be suppressed as compared with the case where the locked portions 242 and 224 are not provided. Accordingly, in the conductive module 3 according to the present modification, the load applied to the solder connection portion between the first electrode of the electrical connection component 30 and the first electrical connection portion 210a of the bus bar-side conductive member 240 and the solder connection portion between the second electrode of the electrical connection component 30 and the second electrical connection portion 220a of the wiring terminal 220B can be suppressed low, and each solder connection portion can be protected. Therefore, the conductive module 3 can maintain conduction performance between the first electrode and the first electrical connection portion 210a and between the second electrode and the second electrical connection portion 220a.

### Third Modification

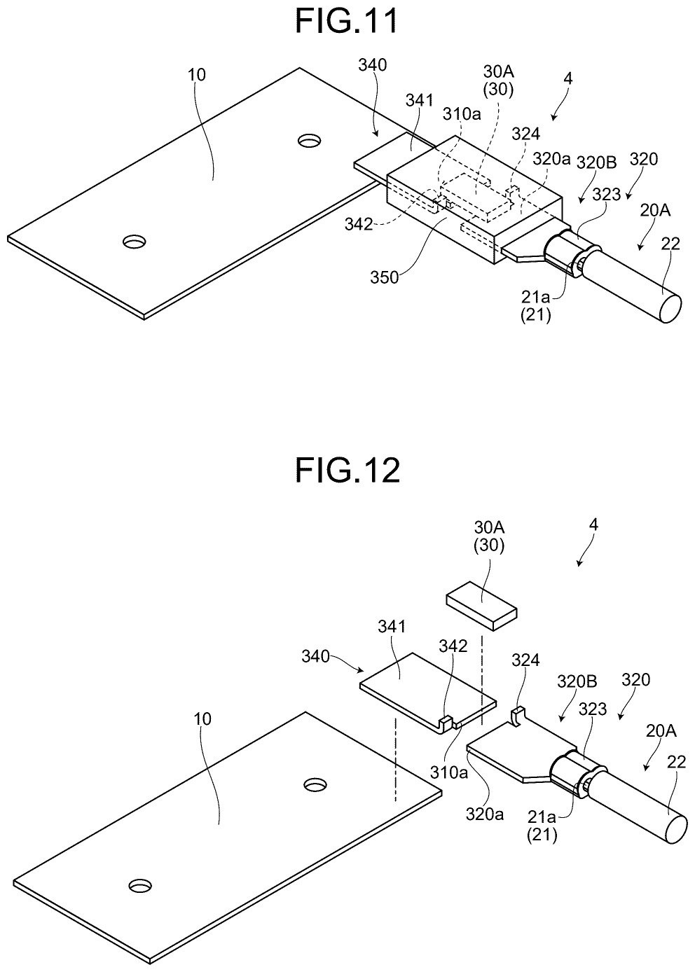

A conductive module 4 of the present modification is obtained by replacing the first electrical connection portion 10a and the second electrical connection portion 20a of the conductive module 1 of the above-described embodiment with first electrical connection portion 310a and second electrical connection portion 320a described below, or by replacing the first electrical connection portion 110a and the second electrical connection portion 20a of the conductive module 2 of the above-described first modification with the first electrical connection portion 310a and second electrical connection portion 320a described below (FIGS. 11 and 12). In addition, the electrical connection component 30 of the present modification may be the chip component 30A or the circuit component 30B as in the embodiment or the first modification.

Here, in the conductive module 1 of the embodiment, the wiring component 20 is replaced with a wiring component 320 described below, and the bus bar-side conductive member 40 is replaced with a bus bar-side conductive member 340 described below (FIGS. 11 and 12). Here, the electrical connection component 30 configured as the chip component 30A is illustrated.

The wiring component 320 of the present modification is obtained by replacing the wiring terminal 20B with a wiring terminal 320B in the wiring component 20 of the embodiment (FIGS. 11 and 12). Similarly to the wiring terminal 20B of the embodiment, the wiring terminal 320B of the present modification is molded as a terminal fitting extending in one direction, and one end thereof in the longitudinal direction is defined as the second electrical connection portion 320a, and the other end thereof in the longitudinal direction is defined as an electric wire connection portion 323. One end side of the wiring terminal 320B in the longitudinal direction is formed in a rectangular flat plate shape, and the second electrode of the electrical connection component 30 is physically and electrically connected to the second electrical connection portion 320a at one end thereof by soldering. Then, the electric wire connection portion 323 illustrated here is formed as a crimp terminal portion to be swaged and crimped to the core wire exposed portion 21a.

Similarly to the bus bar-side conductive member 40 of the embodiment, the bus bar-side conductive member 340 of the present modification is molded as a rectangular flat plate-shaped terminal fitting extending in one direction, and has one end in the longitudinal direction as the first electrical connection portion 310a and the other end in the longitudinal direction as a bus bar connection portion 341 that is physically and electrically connected to the bus bar 10 (FIGS. 11 and 12). The first electrode of the electrical connection component 30 is physically and electrically connected to the first electrical connection portion 310a by soldering. The bus bar-side conductive member 340 physically and electrically connects the bus bar connection portion 341 to the bus bar 10 by welding or the like in a state where the first electrical connection portion 310a protrudes from the bus bar 10 in a direction orthogonal to the arrangement direction of the plurality of battery cells BC.

Also in the present modification, the first electrical connection portion 310a on the bus bar 10 side and the second electrical connection portion 320a of the wiring terminal 320B are disposed to face each other with a gap therebetween in a direction orthogonal to the arrangement direction of the plurality of battery cells BC. Then, also in the present modification, the electrical connection component 30 is installed across the first electrical connection portion 310a and the second electrical connection portion 320a over the gap. In the electrical connection component 30, the first electrode is soldered to the first electrical connection portion 310a, and the second electrode is soldered to the second electrical connection portion 320a.

Similarly to the conductive module 1 of the embodiment, the conductive module 4 includes an insulating member 350 enclosing the electrical connection component 30, the first electrical connection portion 310a, and the second electrical connection portion 320a in order to maintain the connection state (FIG. 11). The insulating member 350 is similar to the insulating member 50 of the embodiment. However, the insulating member 350 of the present modification is adapted to the shapes and disposition of the enclosed electrical connection component 30, first electrical connection portion 310a, and second electrical connection portion 320a.

Similarly to the first electrical connection portion 10a and the second electrical connection portion 20a of the embodiment, the first electrical connection portion 310a and the second electrical connection portion 320a of the present modification have locked portions 342 and 324, respectively, that are in close contact with the insulating member 350 inside and are locked to the insulating member 350 in the facing disposition direction (FIGS. 11 and 12). However, the locked portions 342 and 324 of the present modification are rising walls provided in the first electrical connection portion 310a and the second electrical connection portion 320a, respectively. The rising wall is a wall body rising from each of the first electrical connection portion 310a and the second electrical connection portion 320a in a direction orthogonal to the facing disposition direction of the first electrical connection portion 310a and the second electrical connection portion 320a. In the locked portions 342 and 324, peripheries of the rising walls are surrounded by a part of the insulating member 350.

The locked portion 342 is provided at an end portion of the first electrical connection portion 310a on a second electrical connection portion 320a side and at a position avoiding the electrical connection component 30. The locked portion 342 illustrated here is a wall body rising in a direction orthogonal to the plane of the first electrical connection portion 310a at that position. The locked portion 324 is provided at an end portion of the second electrical connection portion 320a on a first electrical connection portion 310a side and at a position avoiding the electrical connection component 30. The locked portion 324 illustrated here is a wall body rising in a direction orthogonal to the plane of the second electrical connection portion 320a at that position.

The locked portion 342 of the first electrical connection portion 310a and the locked portion 324 of the second electrical connection portion 320a may be disposed so as to face each other in the facing disposition direction of the first electrical connection portion 310a and the second electrical connection portion 320a, or may be disposed so as not to face each other in the facing disposition direction. Here, the latter disposition is adopted.

In the conductive module 4, peripheries of the locked portions 342 and 324 are surrounded by a part of the insulating member 350 in a solidified state, and the locked portions 342 and 324 can be locked by the insulating member 350 around the locked portions 342 and 324. Therefore, in this conductive module 4, when a load causing approaching or separating from each other is applied to the bus bar-side conductive member 340 or the wiring terminal 320B, the force is transmitted from the locked portions 342 and 324 to the insulating member 350 around the locked portions 342 and 324, and the insulating member 350 around the locked portions 342 and 324 receives the force, so that the transmission of the force to the electrical connection component 30 can be suppressed as compared with the case where the locked portions 342 and 324 are not provided. Accordingly, in the conductive module 4 according to the present modification, the load applied to the solder connection portion between the first electrode of the electrical connection component 30 and the first electrical connection portion 310a of the bus bar-side conductive member 340 and the solder connection portion between the second electrode of the electrical connection component 30 and the second electrical connection portion 320a of the wiring terminal 320B can be suppressed low, and each solder connection portion can be protected. Therefore, the conductive module 4 can maintain conduction performance between the first electrode and the first electrical connection portion 310a and between the second electrode and the second electrical connection portion 320a.

In the conductive module according to the present embodiment, each locked portion can be locked inside an insulating member. Therefore, in this conductive module, when a load causing approaching or separating from each other is applied to the bus bar side or a wiring terminal, the force is transmitted from the locked portion to the insulating member, and the insulating member receives the force, so that the transmission of the force to the electrical connection component can be suppressed as compared with the case where the locked portion is not provided. Accordingly, in the conductive module according to the present embodiment, the load applied to the solder connection portion between a first electrode of the electrical connection component and a first electrical connection portion on the bus bar side and the solder connection portion between a second electrode of the electrical connection component and a second electrical connection portion of the wiring terminal can be suppressed low, and each solder connection portion can be protected. Therefore, the conductive module can maintain conduction performance between the first electrode and the first electrical connection portion and between the second electrode and the second electrical connection portion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a bus bar that is physically and electrically connected to an electrode terminal of a battery cell constituting a battery module;
a wiring component that includes a wiring terminal and electrically connects the bus bar to a battery monitoring unit monitoring a battery state of the battery cell;
an electrical connection component that solders a first electrode to a first electrical connection portion on a bus bar side and solders a second electrode to a second electrical connection portion of the wiring terminal; and
an insulating member that encloses the electrical connection component, the first electrical connection portion, and the second electrical connection portion,
wherein
the electrical connection component is a chip component including the first electrode and the second electrode or a circuit component provided with a wiring pattern including the first electrode and the second electrode, and is installed across the first electrical connection portion and the second electrical connection portion disposed to face each other with a gap therebetween,
the insulating member is a molded body insert-molded while enclosing the electrical connection component, the first electrical connection portion, and the second electrical connection portion, or a cured body obtained by curing a potting liquid enclosing the electrical connection component, the first electrical connection portion, and the second electrical connection portion, and
the first electrical connection portion and the second electrical connection portion each have a locked portion that is in close contact with the insulating member inside and is locked to the insulating member in a facing disposition direction.

2. The conductive module according to claim 1, wherein
the locked portion is a through-hole provided in each of the first electrical connection portion and the second electrical connection portion, and the through-hole is filled with a part of the insulating member.

3. The conductive module according to claim 1, wherein
the locked portion is a notch provided in each of the first electrical connection portion and the second electrical connection portion, and the notch is filled with a part of the insulating member, and
the notch includes a notch bottom located in an intersecting direction with respect to the facing disposition direction of the first electrical connection portion and the second electrical connection portion, and a pair of sidewalls facing each other in the facing disposition direction.

4. The conductive module according to claim 1, wherein
the locked portion is a rising wall provided in each of the first electrical connection portion and the second electrical connection portion, and a periphery of the rising wall is surrounded by a part of the insulating member, and
the rising wall is a wall body rising from each of the first electrical connection portion and the second electrical connection portion in a direction orthogonal to the facing disposition direction of the first electrical connection portion and the second electrical connection portion.

5. The conductive module according to claim 1, wherein
the first electrical connection portion is provided in a conductive member physically and electrically connected to the bus bar or in the bus bar.

6. The conductive module according to claim 2, wherein
the first electrical connection portion is provided in a conductive member physically and electrically connected to the bus bar or in the bus bar.

7. The conductive module according to claim 3, wherein
the first electrical connection portion is provided in a conductive member physically and electrically connected to the bus bar or in the bus bar.

8. The conductive module according to claim 4, wherein
the first electrical connection portion is provided in a conductive member physically and electrically connected to the bus bar or in the bus bar.
